(19) United States
(12) Patent Application Publication
(10) Pub. No.: US 2025/0199897 A1
(43) Pub. Date: Jun. 19, 2025

(54) DISASTER ALERT DETECTION AND MANAGEMENT FOR NETWORKS

(71) Applicant: Rakuten Symphony, Inc., Tokyo (JP)

(72) Inventors: Nitin PAL, Indore (IN); Goutam AGRAWAL, Indore (IN); Pravin MUKATI, Indore (IN); Amit VISHWAKARMA, Indore (IN)

(73) Assignee: Rakuten Symphony, Inc., Tokyo (JP)

(21) Appl. No.: 18/539,492

(22) Filed: Dec. 14, 2023

(51) Int. Cl. G06F 11/07

(52) U.S. Cl. CPC G06F 11/0772; G06F 11/0706

(57) ABSTRACT

Provided are an apparatus, method, and device for managing disaster alert detection within a network. According to embodiments, the apparatus may be configured to: retrieve, based on a defined schedule, one or more event-related alerts via a method of procedure (MOP). The apparatus may also send, based on a first request from a user, the retrieved one or more event-related alerts to a management module having a graphical user interface (GUI) portal, wherein the first request may include a request to view the retrieved one or more event-related alerts.

### TECHNICAL FIELD

The present disclosure described herein relates to network alert detection and management for disaster related events.

### BACKGROUND

Alert detection and management for disaster related events is an important process for various geographical areas in the world that are prone to natural disasters. Such process involve a Business Continuity Planning (BCP) team and program managers of a network service provider that need to perform various tasks such as checking and monitoring live alert details and identifying impacted areas and connected network sites in the case of a disaster related event, such as a hurricane, wind, storm, or earthquake, among others.

### SUMMARY

Example embodiments of the present disclosure provide a system, a method, and apparatus that provides simple and automated monitoring, managing, and reporting of various weather or disaster event-related alerts information, including affected network sites of a network service provider in connection with affected geographic areas by the weather or disaster related event. The system of the present disclosure described herein can further manage and map alerts to affected network sites based on geographic area information. In addition, the system allows showing network sites status, history of the network sites, and provide a report (including graphical maps) which can include the number of network sites that were offline or experiencing outage during the weather or disaster related event. Accordingly, the present disclosure described herein provides an efficient automated system that provides continuous updating and reporting of even-related alerts and affected network sites, thus improving the operations of a network services operator and ensuring continuous operations of its network, among other advantages.

According to some embodiments, an apparatus is provided. The apparatus may be configured to: retrieve, based on a defined schedule, one or more event-related alerts via a method of procedure (MOP). The apparatus may also send, based on a first request from a user, the retrieved one or more event-related alerts to a management module having a graphical user interface (GUI) portal, wherein the first request may include a request to view the retrieved one or more event-related alerts.

According to other embodiments, a method is provided. The method may include: retrieving, based on a defined schedule, one or more event-related alerts via a method of procedure (MOP). The method may further include sending, based on a first request from a user, the retrieved one or more event-related alerts to a management module having a graphical user interface (GUI) portal, wherein the first request may include a request to view the retrieved one or more event-related alerts.

According to other embodiments, a non-transitory computer-readable recording medium having recorded thereon instructions executable by an apparatus to cause the apparatus to perform a method is included. The method may include retrieving, based on a defined schedule, one or more event-related alerts via a method of procedure (MOP). The method may further include sending, based on a first request from a user, the retrieved one or more event-related alerts to a management module having a graphical user interface (GUI) portal, wherein the first request may include a request to view the retrieved one or more event-related alerts.

### BRIEF DESCRIPTION OF THE DRAWINGS

Features, advantages, and significance of example embodiments of the disclosure will be described below with reference to the accompanying drawings, in which like signs denote like elements, and wherein:

FIG. 1 illustrates a diagram of a general system architecture of the present disclosure described herein, according to one or more embodiments;

FIG. 2 illustrates a diagram of various modules and components for the present disclosure described herein, according to one or more embodiments;

FIG. 3 illustrates a diagram of various modules, components, and a process flow for the present disclosure described herein, according to one or more embodiments;

FIG. 4 illustrates a process flow diagram for the present disclosure described herein, according to one or more embodiments;

FIG. 5 illustrates a process flow diagram for the present disclosure described herein, according to one or more embodiments;

FIG. 6 illustrates a diagram of various modules and components for the present disclosure described herein, according to one or more embodiments;

FIG. 7 illustrates a process flow diagram for the present disclosure described herein, according to one or more embodiments;

FIG. 8 illustrates a process flow diagram for the present disclosure described herein, according to one or more embodiments; and

FIGS. 9-14 illustrate portals of graphical user interfaces for the present disclosure described herein, according to one or more embodiments.

### DETAILED DESCRIPTION

The following detailed description of example embodiments refers to the accompanying drawings. The same reference numbers in different drawings may identify the same or similar elements.

The foregoing disclosure provides illustrations and descriptions, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” “non-limiting example embodiment,” or similar language means that a particular feature, structure, or characteristic described in connection with the indicated embodiment is included in at least one embodiment of the present solution. Thus, the phrases “in one embodiment”, “in an embodiment,” “in one non-limiting example embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

In one implementation of the present disclosure described herein, a display page may include information residing in the computing device's memory, which may be transmitted from the computing device over a network to a database center and vice versa. The information may be stored in memory at each of the computing device, a data storage resided at the edge of the network, or on the servers at the database centers. A computing device or mobile device may receive non-transitory computer readable media, which may contain instructions, logic, data, or code that may be stored in persistent or temporary memory of the mobile device, or may somehow affect or initiate action by a mobile device. Similarly, one or more servers may communicate with one or more mobile devices across a network, and may transmit computer files residing in memory. The network, for example, can include the Internet, wireless communication network, or any other network for connecting one or more mobile devices to one or more servers.

Any discussion of a computing, user device, user equipment, mobile device may also apply to any type of networked device, including but not limited to mobile devices and phones such as cellular phones (e.g., any “smart phone”), a personal computer, server computer, or laptop computer; personal digital assistants (PDAs); a roaming device, such as a network-connected roaming device; a wireless device such as a wireless email device or other device capable of communicating wireless with a computer network; or any other type of network device that may communicate over a network and handle electronic transactions. Any discussion of any mobile device mentioned may also apply to other devices, such as devices including short-range ultra-high frequency (UHF) device, near-field communication (NFC), infrared (IR), and Wi-Fi functionality, among others.

Phrases and terms similar to “software”, “application”, “app”, and “firmware” may include any non-transitory computer readable medium storing thereon a program, which when executed by a computer, causes the computer to perform a method, function, or control operation.

Phrases and terms similar to “network” may include one or more data links that enable the transport of electronic data between computer systems and/or modules. When information is transferred or provided over a network or another communications connection (either hardwired, wireless, or a combination of hardwired or wireless) to a computer, the computer uses that connection as a computer-readable medium. Thus, by way of example, and not limitation, computer-readable media can also include a network or data links which can be used to carry or store desired program code means in the form of computer-executable instructions or data structures and which can be accessed by a general purpose or special purpose computer.

Phrases and terms similar to “portal” or “terminal” may include an intranet page, internet page, locally residing software or application, mobile device graphical user interface, or digital presentation for a user. The portal may also be any graphical user interface for accessing various modules, components, features, options, and/or attributes of the present disclosure described herein. For example, the portal can be a web page accessed with a web browser, mobile device application, or any application or software residing on a computing device.

As described above, alert detection and management for disaster related events involve BCP team and program managers of a network service provider checking and monitoring live alert details and identifying impacted areas and connected network sites in the case of a disaster related event.

In the related art, such processes are performed manually. Generally, the BCP team needs to first locate and identify all of the affected sites with the network team and then gather all of the ongoing alarm information from a fault management team or fault management module. In the initial phases, evaluating the impact of a disaster or natural calamity on the network is challenging. The maintenance team is required to physically visit all the affected sites to determine when they experienced outages and when they were successfully restored. This process consumes a significant amount of time and effort. Consequently, the team faces difficulties in accurately identifying the precise impact of the disaster on the operational network.

Further, to create a final report, the BCP team needs to manually merge all of this information and monitor all live alarms on a regular basis, which can be time-consuming and impractical.

These difficulties and delays hamper the BCP team from promptly reporting the disaster's impact to the Ministry of Internal Affairs and Communications (MIC).

Accordingly, system, methods, devices, and the like, provided in the example embodiments of the present disclosure manage disaster alert detection, which allows for simple monitoring, managing, and reporting of disaster and weather-related events alert information, including network sites within affected geographic areas.

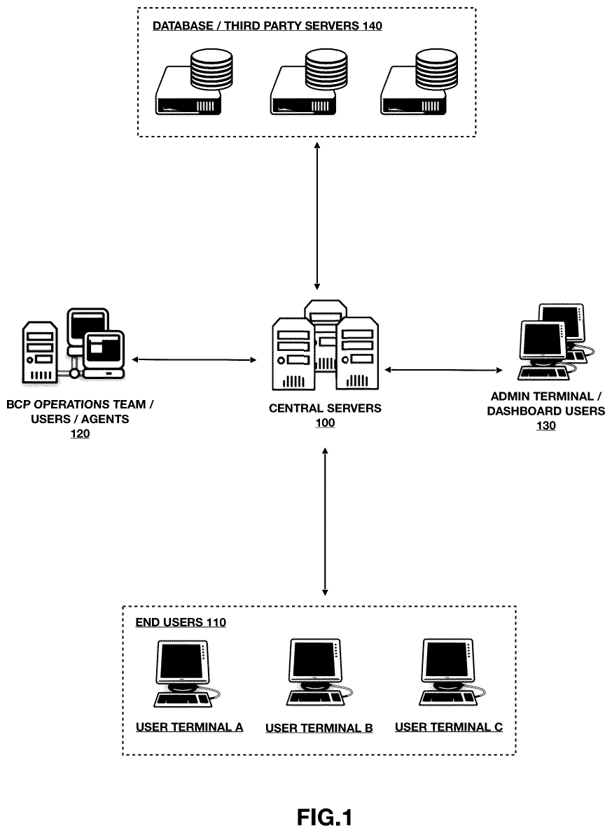

FIG. 1 illustrates a diagram of a general network architecture according to one or more embodiments. Referring to FIG. 1, end users 110, BCP operations network support team/users/agents 120, and admin terminal/dashboard users 130 (collectively referred to herein as users 110, 120, and 130) can be in bi-directional communication over a secure network with central servers or application servers 100 according to one or more embodiments. In addition, users 110, 120, 130 may also be in direct bi-directional communication with each other via the network system of the present disclosure described herein according to one or more embodiments. Here, users 110 can be any type of customer, subscriber, network service provider agent, or vendor, among others, of a network or telecommunication service provider, such as users operating computing devices and user terminals A, B, and C. Each of users 110 can communicate with servers 100 via their respective terminals or portals. Users 120 can include BCP program managers, operations team, support team, agents, and users of the network service provider or operator for developing, integrating, and monitoring databases, systems and services, network traffic, and provisioning traffic, among others, including assisting, scheduling, and modifying network events, and providing support services to end users 110. Admin terminal/dashboard users 130 may be any type of user with access privileges for accessing a dashboard or management portal of the present disclosure described herein, wherein the dashboard portal can provide various user tools, GUI information, maps, open/closed/pending support tickets, graphs, customer support options, network status and performance, and KPIs, among others. It is contemplated within the scope of the present disclosure described herein that any of users 110 and 120 may also access the admin terminal/dashboard 130 of the present disclosure described herein.

Still referring to FIG. 1, central servers 100 of the present disclosure described herein according to one or more embodiments can be in further bi-directional communication with database/third party servers 140, which may also include users. Here, servers 140 can include various meteorology agencies, weather reporting and notification systems, environmental disaster notification and database systems, event related systems, among others. In addition, servers 140 can include servers and databases for streaming various types of data, captured, collected, or aggregated data, such as current, real-time, and past network related historical and KPI data which may be stored thereon and retrieved therefrom for network analysis, energy consumption calculations (including energy from renewable sources), artificial intelligence (AI) processing, neural network models, machine learning, predictions, and simulations by servers 100. However, it is contemplated within the scope of the present disclosure described herein that the database migration system and method of the present disclosure described herein can include any type of general network architecture.

Still referring to FIG. 1, one or more of servers or terminals of elements 100-140 may include a personal computer (PC), a printed circuit board comprising a computing device, a mini-computer, a mainframe computer, a microcomputer, a telephonic computing device, a wired/wireless computing device (e.g., a smartphone, a personal digital assistant (PDA)), a laptop, a tablet, a smart device, a wearable device, or any other similar functioning device.

In some embodiments, as shown in FIG. 1, one or more servers, terminals, and users 100-140 may include a set of components, such as a processor, a memory, a storage component, an input component, an output component, a communication interface, and a JSON UI rendering component. The set of components of the device may be communicatively coupled via a bus.

The bus may comprise one or more components that permit communication among the set of components of one or more of servers or terminals of elements 100-140. For example, the bus may be a communication bus, a cross-over bar, a network, or the like. The bus may be implemented using single or multiple (two or more) connections between the set of components of one or more of servers or terminals of elements 100-140. The disclosure is not limited in this regard.

One or more of servers or terminals of elements 100-140 may comprise one or more processors. The one or more processors may be implemented in hardware, firmware, and/or a combination of hardware and software. For example, the one or more processors may comprise a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), a general purpose single-chip or multi-chip processor, or other programmable logic device, discrete gate or transistor logic, discrete hardware components, or any combination thereof designed to perform the functions described herein. A general purpose processor may be a microprocessor, or any related art processor, controller, microcontroller, or state machine. The one or more processors also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function.

The one or more processors may control overall operation of one or more of servers or terminals of elements 100-140 and/or of the set of components of one or more of servers or terminals of elements 100-140 (e.g., memory, storage component, input component, output component, communication interface, rendering component).

One or more of servers or terminals of elements 100-140 may further comprise memory. In some embodiments, the memory may comprise a random access memory (RAM), a read only memory (ROM), an electrically erasable programmable ROM (EEPROM), a flash memory, a magnetic memory, an optical memory, and/or another type of dynamic or static storage device. The memory may store information and/or instructions for use (e.g., execution) by the processor.

A storage component of one or more of servers or terminals of elements 100-140 may store information and/or computer-readable instructions and/or code related to the operation and use of one or more of servers or terminals of elements 100-140. For example, the storage component may include a hard disk (e.g., a magnetic disk, an optical disk, a magneto-optic disk, and/or a solid state disk), a compact disc (CD), a digital versatile disc (DVD), a universal serial bus (USB) flash drive, a Personal Computer Memory Card International Association (PCMCIA) card, a floppy disk, a cartridge, a magnetic tape, and/or another type of non-transitory computer-readable medium, along with a corresponding drive.

One or more of servers or terminals of elements 100-140 may further comprise an input component. The input component may include one or more components that permit one or more of servers and terminals 100-140 to receive information, such as via user input (e.g., a touch screen, a keyboard, a keypad, a mouse, a stylus, a button, a switch, a microphone, a camera, and the like). Alternatively or additionally, the input component may include a sensor for sensing information (e.g., a global positioning system (GPS) component, an accelerometer, a gyroscope, an actuator, and the like).

An output component any one or more of servers or terminals of elements 100-140 may include one or more components that may provide output information from the device 100 (e.g., a display, a liquid crystal display (LCD), light-emitting diodes (LEDs), organic light emitting diodes (OLEDs), a haptic feedback device, a speaker, and the like).

One or more of servers or terminals of elements 100-140 may further comprise a communication interface. The communication interface may include a receiver component, a transmitter component, and/or a transceiver component. The communication interface may enable one or more of servers or terminals of elements 100-140 to establish connections and/or transfer communications with other devices (e.g., a server, another device). The communications may be enabled via a wired connection, a wireless connection, or a combination of wired and wireless connections. The communication interface may permit one or more of servers or terminals of elements 100-140 to receive information from another device and/or provide information to another device. In some embodiments, the communication interface may provide for communications with another device via a network, such as a local area network (LAN), a wide area network (WAN), a metropolitan area network (MAN), a private network, an ad hoc network, an intranet, the Internet, a fiber optic-based network, a cellular network (e.g., a fifth generation (5G) network, sixth generation (6G) network, a long-term evolution (LTE) network, a third generation (3G) network, a code division multiple access (CDMA) network, and the like), a public land mobile network (PLMN), a telephone network (e.g., the Public Switched Telephone Network (PSTN)), or the like, and/or a combination of these or other types of networks. Alternatively or additionally, the communication interface may provide for communications with another device via a device-to-device (D2D) communication link, such as FlashLinQ, WiMedia, Bluetooth, ZigBee, Wi-Fi, LTE, 5G, and the like. In other embodiments, the communication interface may include an Ethernet interface, an optical interface, a coaxial interface, an infrared interface, a radio frequency (RF) interface, or the like. It is understood that other embodiments are not limited thereto, and may be implemented in a variety of different architectures (e.g., bare metal architecture, any cloud-based architecture or deployment architecture such as Kubernetes, Docker, OpenStack, etc.).

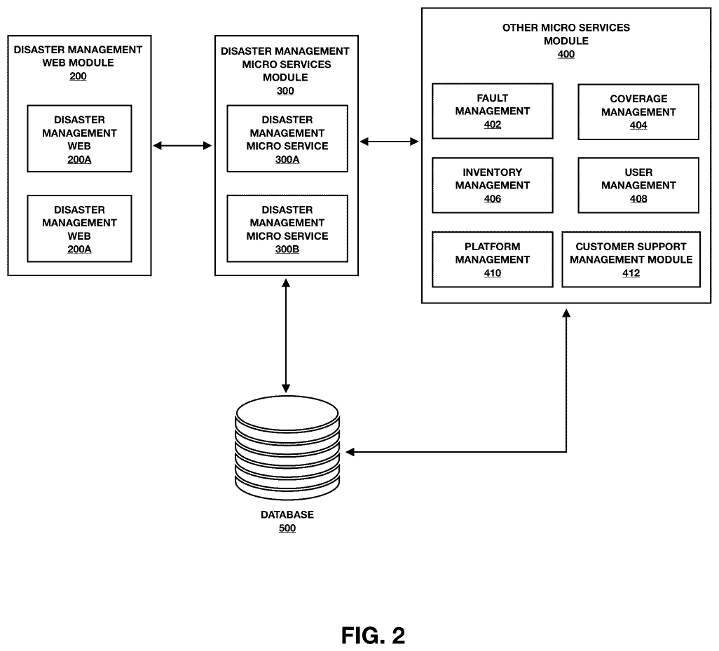

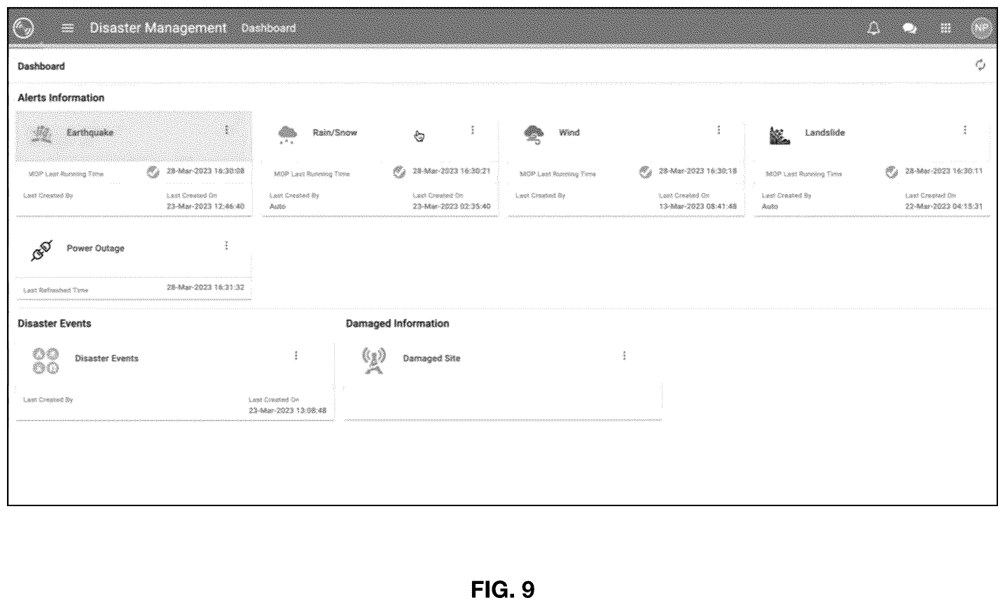

FIG. 2 illustrates various modules and components for a disaster alert detection and management system, method, and apparatus of the present disclosure described herein for network service providers, according to one or more example embodiments. In addition, the system of the present disclosure described herein can assist emergency responders, disaster relief organizations, and governments in managing and responding to various types of disasters, including but not limited to, human-caused or natural disasters, earthquakes, volcanic eruptions, landslides, floods, heat waves, cold waves, wildfires, droughts, cyclones, hurricanes, tornados, hailstorms, wind, rain, snow, epidemics, pandemics, technological and biological hazards, among others. In particular, the system of the present disclosure described herein can include a disaster management web module 200 having multiple sub-modules, such as disaster management web sub-modules 200A and 200B. Here, module 200, and any sub-modules, can generally be any type of portal or user terminal having a GUI for managing, reporting, and viewing various types of disaster and event related notifications, such as shown in FIGS. 9-12, and which will later be discussed in more detail. In addition, the present disclosure described herein can also include a disaster management micro services module 300, which can also include various sub-modules, such as disaster management micro service sub-modules 300A and 300B. Here, module 300 can include various types of services, such as creating alert Application Programming Interfaces (APIs), validating various parameters, and saving various alerts and disaster related information in a database. Here, module 300, including sub-modules 300A and 300B, can communicate bidirectionally with module 200, module 400, and database 500.

Still referring to FIG. 2, the present disclosure described herein can further include another micro services module 400. Here, module 400 can also include various sub-modules, such as a fault management module 402, coverage management module 404, inventory management module 406, user management module 408, platform management module 410, and customer support module 412. Here module 400, including any one or more of sub-modules 402-412 can communicate bi-directionally with database 500 and module 300. Here, the various sub-modules of module 400 allow for more efficient operations, such that each sub-module can be configured for a particular task.

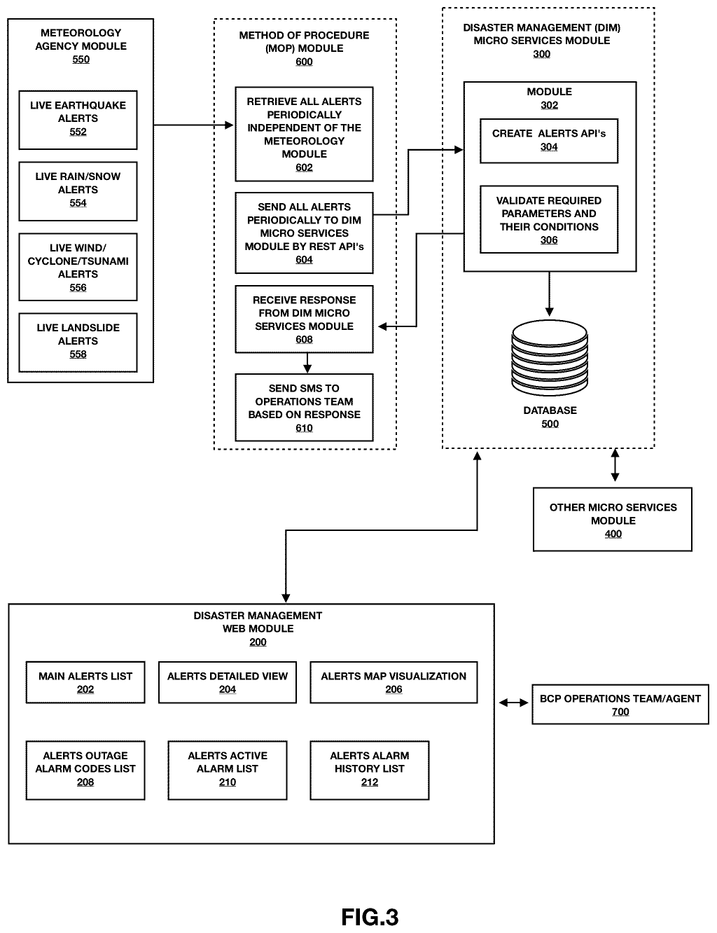

FIG. 3 illustrates various modules, components, and a process flow for the present disclosure described herein, according to one or more embodiments. In particular, FIG. 3 illustrates a general alert notification and management process flow. Generally, the process can include the following steps, according to one embodiment: 1) When any alerts are received by a meteorology agency for any geographic area, the agency will register the alert information in their database; 2) a method of procedure (MOP) can check the meteorology agency's database periodically (or every five-minutes) for new alerts and if any new alerts are found, the alerts will then be registered in a disaster management module of the present disclosure described herein; 3) the system of the present disclosure described herein can then check all the parameters of the alert and the affected areas, maps (or links or associates) all the affected and damaged network sites to the alert (such as wind/snow) and sends a response to the MOP, where the response may include a validation as well as a corresponding disaster management (DIM) micro services module's share register alert ID for SMS notification; 4) the MOP checks the response and if it is successful, sends a notification (or SMS message) to BCP agent or team; 5) the BCP agent can then log into the disaster management web module and view specific alert details (by sending a request to view such specific alert details), including network affected site listings, damaged site listings, and map visualizations of those sites, among others; 6) a user or the BCP agent can configure various outage alarm codes in an administration section of the disaster management web module and the system can fetch the configured outage alarm codes available for damage site calculations; and 7) the user or BCP agent can also check all active and closed alarm histories of any individual network site for detailed information, which can be made available in the database of the present disclosure described herein. In particular, the system of the present disclosure described herein can detect live weather or disaster event-related alerts and affected areas from various sources. In addition, the system allows showing network sites status, history of the network sites, and provide a report (including graphical maps) which can include the number of network sites that were offline or experiencing an outage during the weather or disaster related event. Accordingly, the present disclosure described herein provides an efficient automated system that provides continuous updating and reporting of even-related alerts and affected network sites, thus improving the operations of a network service provider and ensuring continuous operations of its network, among other advantages.

Still referring to FIG. 3, in another embodiment, the process can start at a meteorology agency module 550, which can be any type of weather-based or environmental agency or entity for tracking and providing notifications and alerts for weather and environmental related events or disasters (including natural and non-natural), such as earthquakes, rain, snow, wind, cyclone, tsunami, landslides, among others. Here, modules 550 can include various sub-modules for providing various types of live or real-time alerts, such as a live earthquake alerts module 552, live rain/snow alerts module 554, live wind/cyclone/tsunami alerts 556, and live landslide alerts 558. Here, when any type of weather, environmental, or disaster related event is identified by module 550 (including present and future events) for any geographic area, module 550 will save such event-related information in their databases. Next, a method of procedure (MOP) module 600, can check the databases of module 550 for any type of weather, environmental, or disaster type event or alert that has been recently or newly recorded, saved, or identified by module 550, such as via an API. Once a new or recent event has been identified by module 600, sub-module 602 can then periodically retrieve or receive such event-related alerts (or based on a defined time interval). Next, the present disclosure described herein can then save that alerts related information within database 500. In particular, sub-module 604 can periodically (or based on a defined time interval) send all received event-related alerts from sub-module 602 to the disaster micro services module 300 via rest API's.

Still referring to FIG. 3, disaster management (DIM) micro services module 300 can include a sub-module 302 that further includes a sub-module 304 for creating API's in connection with the event-related alerts. Next, a sub-module 306 can validate various required parameters and conditions in connection with the event-related alerts, in order to ensure accuracy of the information. For example, the sub-module 306 can perform validation based on alerts received from the meteorology agency, and may validate null values in JavaScript Object Notation (JSON) file shared by Robust Multi-Objective and Multidisciplinary Optimization Platform (RMOP). Once the alerts are validated (and/or failed validation), the alerts can then be saved within database 500 or discarded. In addition, module 300 can send sub-module 608 a success or failure notification with respect to validation of the alerts. Further, sub-module 604 can periodically send all validated alerts to the disaster management (DIM) micro services web module 300 via rest API's. Next, if an alert has been validated, sub-module 610 can then send a notification or message (such as an SMS message) to an operations team or BCP agent, wherein the notification or message can include the alert, any additional steps to be taken, or contingency plans for continuation of the network services, among others.

Still referring to FIG. 3, DIM micro services module 300 can also be in bi-directional communication with disaster management web module 200 for sending to and receiving information from module 300. Further, module 200 is also in bi-directional communication with a BCP operations team or agent user, terminal, or module 700. Here, disaster management web module 200 can include a main alerts list module 202 for listing the event-related alerts, an alerts detailed view module 204 for providing additional details on the alert (such as the extent and duration of the event), and alerts map visualization module 206 for providing graphical map of network sites in relation to the alerts and the event, an alerts outage alarm codes list module 208 for various types of alarms associated with one or more events, an alerts active alarm list module 210, and alerts alarm history list module 212. In addition, DIM micro services module 300 can also be in bi-directional communication with other micro services module 400 for sending to and receive information from module 400. Here, various sub-modules of module 200 provide various types of customizable alert configurations depending on the event, such as high priority alarm for a particular event (e.g., earthquake) or a low priority alarm for another event (e.g., rain).

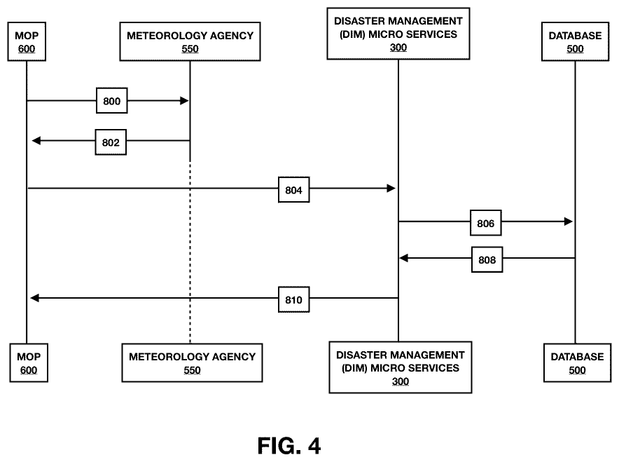

FIG. 4 illustrates a process flow diagram for the present disclosure described herein, according to one or more embodiments. In one embodiment, the process can begin at step 800 wherein MOP module 600 sends a request to a meteorology agency module 550 (or any source) to receive one or more live event-related alerts information. Next, at step 802 module 550 can send any new or recent alerts to MOP module 600. At step 804, MOP module 600 can call rest API's and send the received alerts to the DIM micro services module 300. Next, at step 806, DIM module 300 can validate various parameters and conditions in connection with the alerts and save them into database 500. At step 808, database 500 can send a return response to DIM module 300 as to whether the alerts are validated. Next at step 810, DIM module 300 can then send the return response from database 500 to MOP 600, indicating success or failure of the alert validation process.

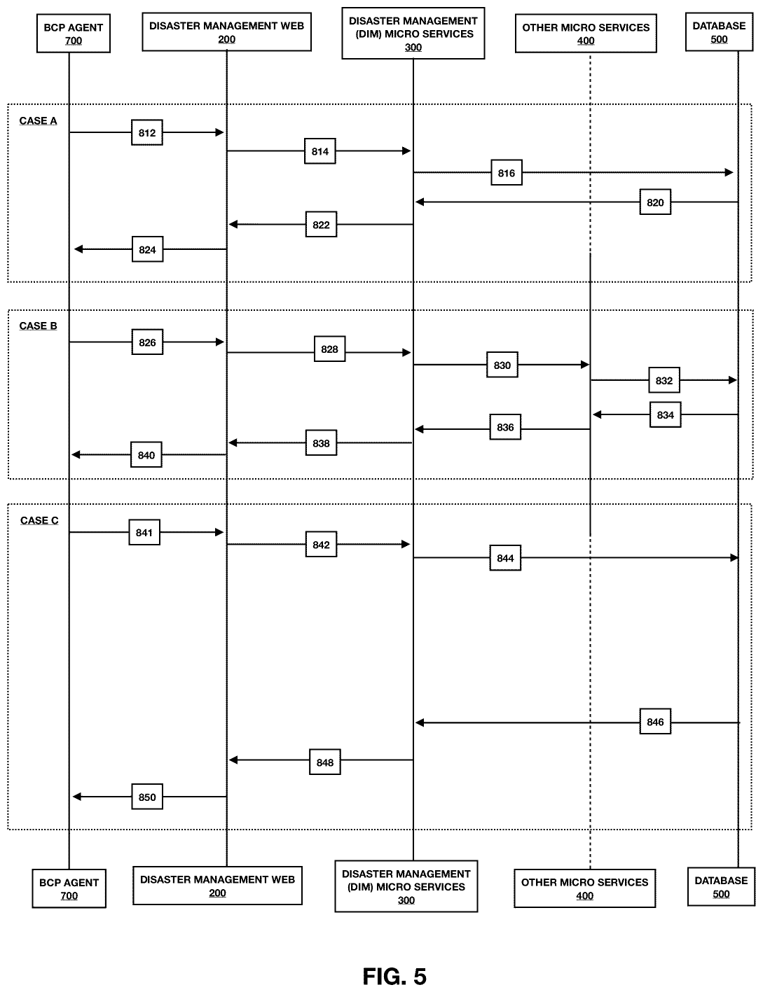

FIG. 5 illustrates a process flow diagram for the present disclosure described herein, according to one or more embodiments. Here, FIG. 5 illustrates various example case scenarios for process flow of the present disclosure described herein. For example, in Case A, the process can begin at step 812, wherein a BCP agent 700 sends a request to the disaster management web module 200 to view an alerts list, such as in relation to various events, including but not limited to earthquakes, rain, wind, and snow. Next, at step 814, module 200 sends a request to DIM module 300 to receive all the alerts list in connection with the various events. At step 816, DIM module sends a request to database 500 to retrieve the foregoing alerts list. At step 820, database 500 sends the alerts list to DIM module 300 (or DIM module 300 retrieves it from database 500). At step 822, DIM nodule 300 further sends the retrieved alerts list to module 200, and wherein at step 824 module 200 provides the alerts information to agent 700 via the disaster management web portal, wherein the agent can view the requested information via a GUI.

Still referring to FIG. 5, in another example, Case B, the process can begin at step 826, wherein agent 700 sends a request to the disaster management web module 200 to view active alarms and the alarm history of an alert. Next, at step 828, module 200 sends a request to DIM module 300 to retrieve an alarm listing of an alert. At step 830, DIM module 300 generates a request to retrieve from the other micro services module 400 the alarm listing from a fault management micro service, such as via the fault management module 402. At step 832, module 400 can then send a request to database 500 to retrieve the requested alarm listing. At step 834, the database sends the alarm listing information to module 400 which in turn sends the information to DIM module 300 at step 836. Next, at step 838, DIM module 300 sends to module 200 the list of the active alarms and alarm history list of the alert. At step 840, module 200 then provides the information to agent 700 via the disaster management web portal, which can be viewed by the agent via a GUI.

Still referring to FIG. 5, in another example, Case C, the process can begin at step 841, wherein agent 700 sends a request to disaster management web module 200 to view or edit DIM configured alarm codes. Next, at step 842, module 200 can generate the edit or view request and send the generated request to DIM module 300. At step 844, DIM module 300 can send the edit or view request to database 500 to retrieve the configured alarm codes. At step 846, database 500 can send a response to DIM module 300 based on request, including sending updated alarm codes information. Next, at step 848, DIM module 300 sends the response from the database to module 200. At step 850, module 200 provides the response to agent 700, including updated alarm codes information that can be viewed and edited (and also saved to database 500).

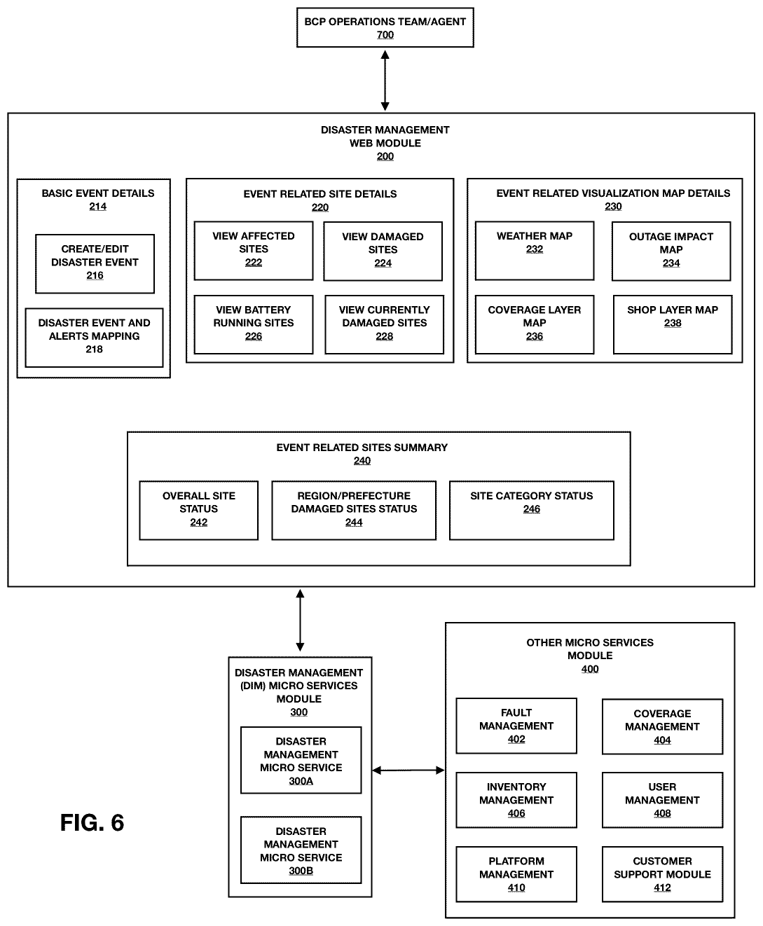

FIG. 6 illustrates a diagram of various modules, components, and a process flow for the present disclosure described herein, according to one or more embodiments. In particular, FIG. 6 illustrates a disaster event and mapping of the events with alerts process flow. Generally, the process can include the following steps, according to one embodiment: 1) Within the disaster management web module 200, the user can manually create an event to track specific alerts under one event; 2) within module 200, the user can then map (linking and associating) alerts and events with each other; and 3) the user can monitor, via the event mapping feature, all associated alerts and the network sites affected and damage within a single window having geographic map visualizations and further view a detailed analysis of the alert's information in connection with the total affected sites, total damaged sites, and current damaged sites.

Still referring to FIG. 6, the disaster web management module 200 is shown to be in bi-directional communication with BCP operations team/agent 700. Further, module 200 can include various sub-modules, such as a basic events detail module 214, event related site details module 220, event related visualization map details module 230, and an event related sites summary module 24. In particular, module 214 may further include a create/edit disaster event module 216 and a disaster event and alerts mapping module 218. Further, module 220 can include a view affected sites module 222, view damaged sites module 224, view sites operating on battery module 226, and view currently damaged sites module 228. In addition, module 230 can include a visual weather map module 232, visual outage impact map module 234, visual coverage layer map module 236, and a visual shop later module 238. Further, module 240 can include an overall site status module 242, a damaged sites status based on a region/prefecture module 244, and a site category status module 246. Here, the disaster management web module 200 can be in further bi-directional communication with DIM micro services module 300. In addition, DIM micro services module 300 can be in further bi-directional communication with the other micro services module 400.

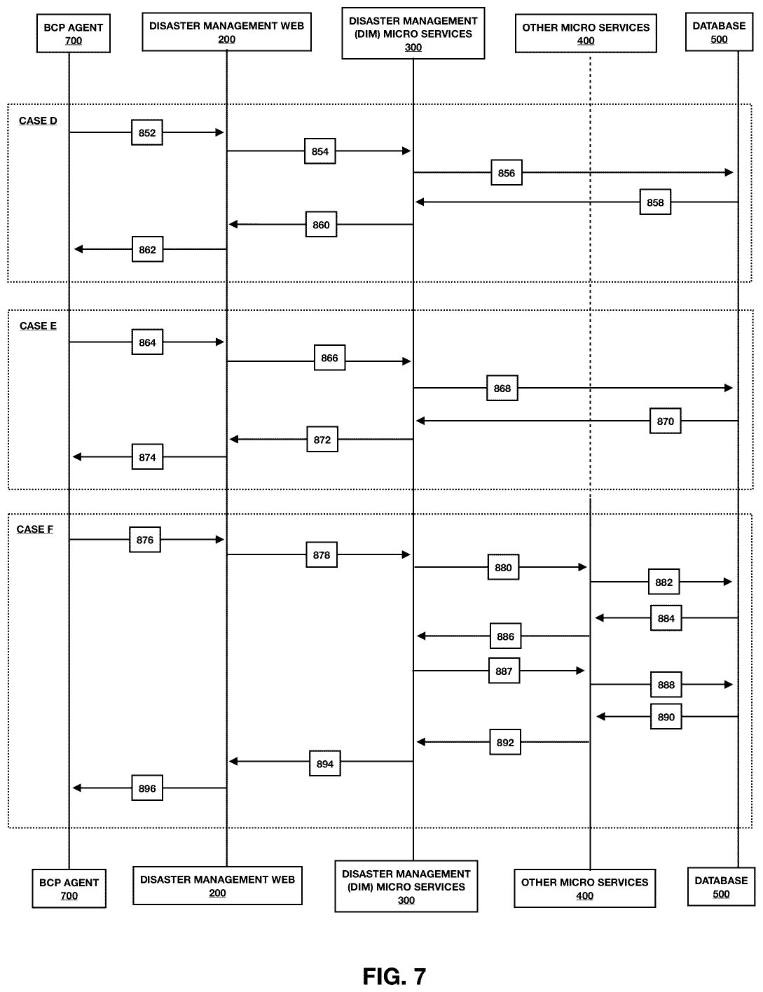

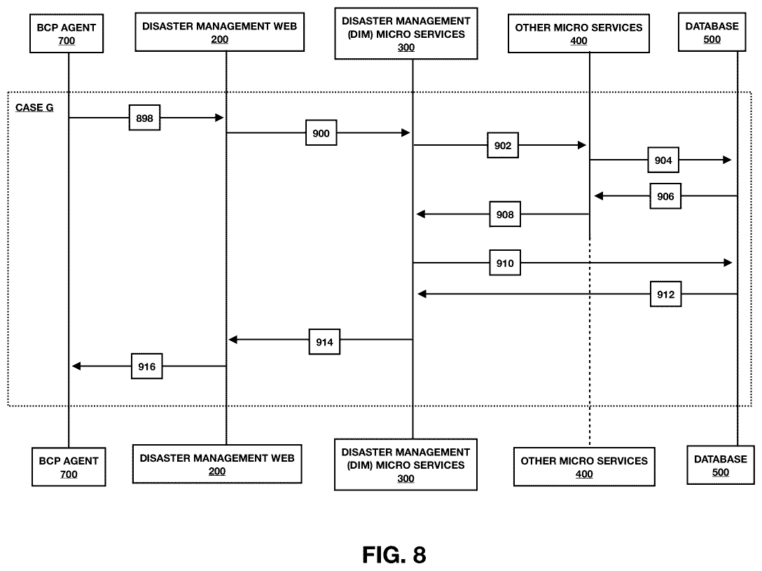

FIGS. 7-8 illustrates additional process flow diagrams for the present disclosure described herein, according to one or more embodiments. Here, FIG. 7 illustrates various example case scenarios for process flow of the present disclosure described herein. For example, in Case D, the process can begin at step 852, wherein a BCP agent 700 sends a request to the disaster management web module 200 to create or edit one or more disaster events. Next, at step 854, module 200 generates the foregoing requests and sends it to the DIM module 300. At step 856, DIM module 300 sends a request to database 500 to edit or change the disaster events or retrieve the one or more events. At step 858 the database makes the edit or change and sends a response back to DIM module 300. At step 860, DIM module 300 sends the response with the edited or changed event information to module 300. At step 862, module 300 provides the event information to BCP agent 700, which can be viewed and edited by the agent via a GUI.

Still referring to FIG. 7, in another example, Case E, the process can begin at step 864, wherein BCP agent 700 sends a request to disaster management web module 200 in order to request a current, updated, or recent mappings of alerts. At step 866, module 200 generates and sends the foregoing request to DIM module 300. At step 868, DIM module 300 further sends the request to database 500 to retrieve an updated listing of the most recent alert mappings for a given event. At step 870, database 500 provides a response back to DIM module 300 with the updated mappings. At step 872, DIM module 300 sends the updated event alert mappings to module 200. At step 874, modules provides the updated or most recent event alert mappings to BCP agent 700, which can be viewed or configured by the agent via a GUI.

Still referring to FIG. 7, in another example, Case F, the process can begin at step 876, wherein BCP agent 700 sends a request to the disaster management web module 200 to view all affected, damaged, currently damaged, and battery running network sites (or sites running alternative energy sources). At step 878, module 200 generates and sends the foregoing request to DIM module 300. At step 880, DIM module 300 sends a request for the affected sites information to the other micro services module 400, namely the inventory management module 406. At step 882, module 400 sends the request for such information to database 500 to retrieve the information. At step 884, database 500 returns the foregoing information to module 400. At step 886, module 400, via the inventory management module 406, sends the received information to DIM module 300. At step 887, DIM module 300 sends a separate request for the damaged, currently damaged, and battery running network sites information to module 400, namely, the fault management module 402. At step 888, module 400 further sends a request to database 500 to retrieve the foregoing information. At step 890, database 500 sends a response back to module 400 with the requested information. At step 892, module 400, via fault management module 402, sends the received information to DIM module 300. Next, at step 894, DIM module 300 sends the received information from steps 886 and 892 back to the disaster management web module 300. At step 896, module 300 provides the most recent affected, damaged, currently damaged, and battery running network sites information to BCP agent 700, which can be viewed or configured by the agent via a GUI.

Referring to FIG. 8, in another example, Case G, the process can begin at step 898, wherein a BCP agent 700 sends a request to the disaster management web module 200 to view various types of data on a visualization map, such as an outage impact map, weather map, coverage layer map, and shop layer map, among others. At step 900, module 200 generates and sends the foregoing request to DIM module 300. At step 902, DIM module 300 sends a request to the other micro services module 400, via the fault management module 402, for the outage impact map information. At step 904, module 400 sends the foregoing request to database 500 to retrieve the outage impact map information. At step 906, database 500 sends a response with the requested impact map information back to module 400. At step 908, module 400, via the fault management module 402, sends the impact map information to DIM module 300. At step 910, DIM module 300 sends a request to database 500 to retrieve the weather map, coverage layer map, and shop layer map information. At step 912, DIM module 300 receives a response back from database 500 with the weather map, coverage layer map, and shop layer map information. At step 914, DIM module 300 sends the information received at steps 908 and 912 to the disaster management web module 200. At step 916, module 200 provides the requested and updated map information to BCP agent 700, which can be viewed or configured by the agent via a GUI.

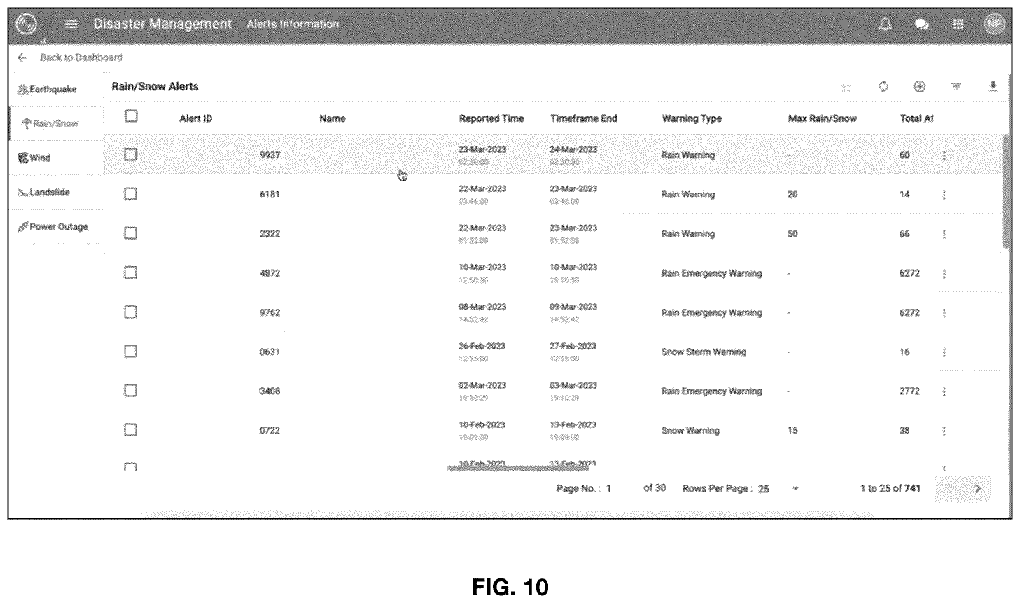

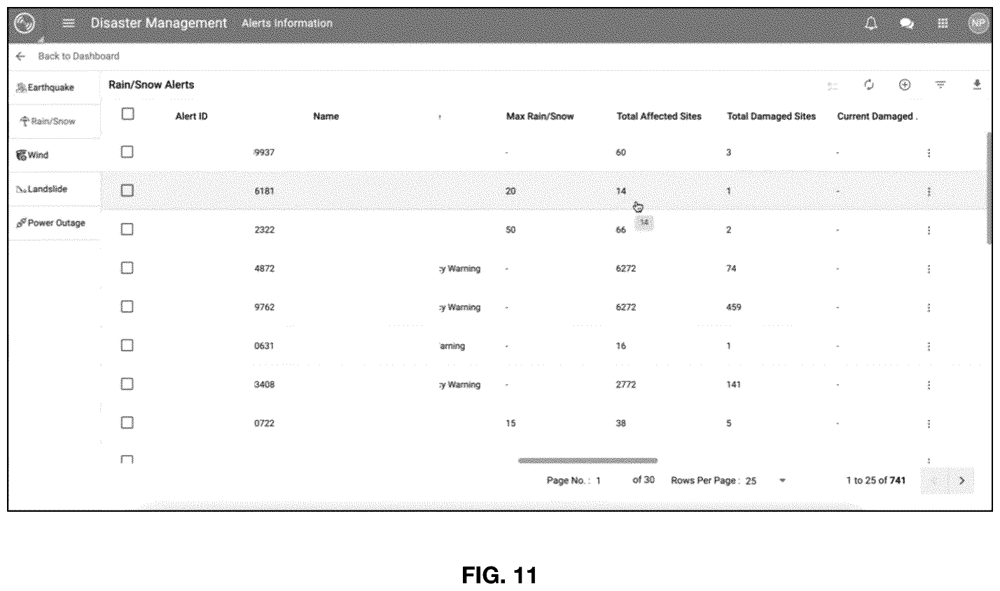

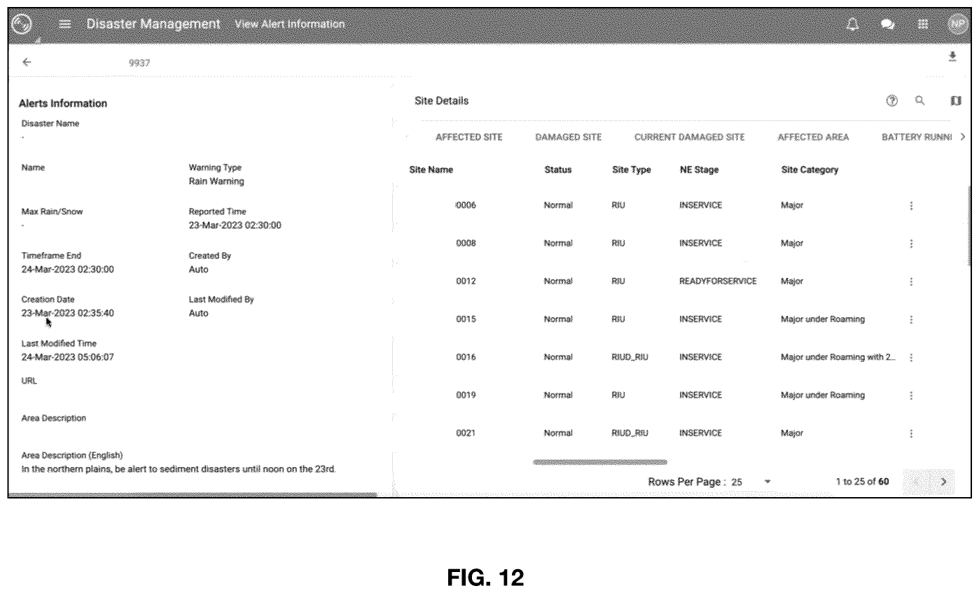

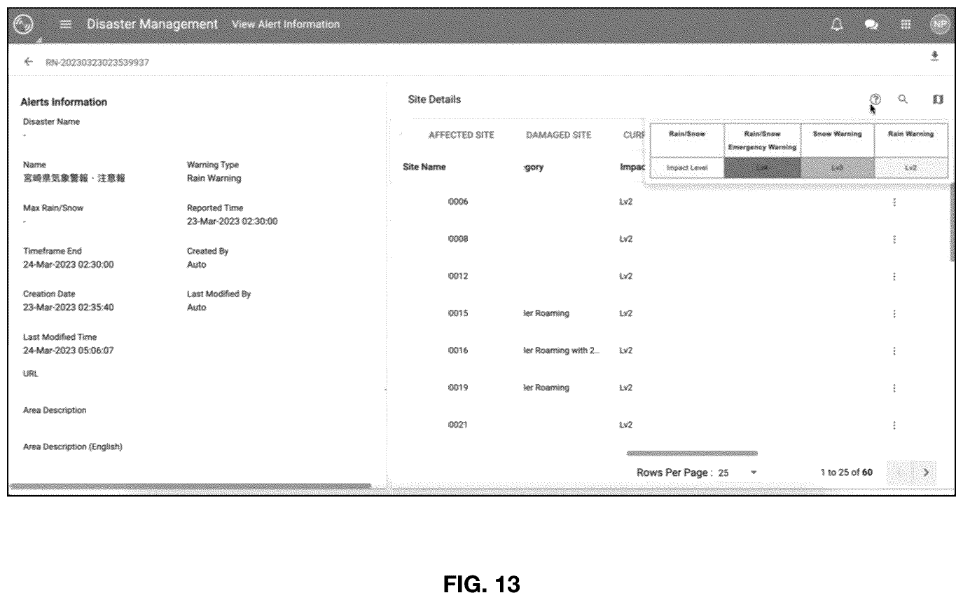

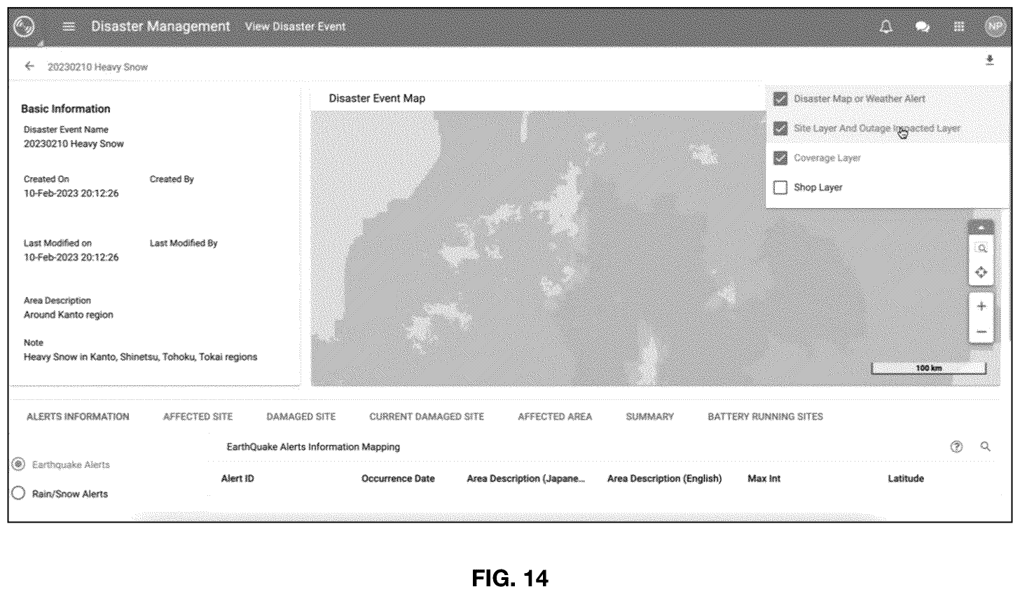

FIGS. 9-12 illustrate example GUI portals with respect to the disaster management web module 200 of the present disclosure described herein, according to one or more example embodiments. In particular, FIG. 9 illustrates a dashboard portal showing various real-time basic alerts information in connection with events such as earthquakes, rain/snow, wind, landslides, power outages. In addition, the dashboard can also show disaster events and damage information, such as damaged or affected network sites. FIGS. 10-11 illustrates a dashboard showing detailed alerts information, such as pertaining to rain/snow. Such detailed information can include, but it not limited to, alert ID, name, alert report time, timeframe end, warning type, maximum rain/snow precipitation, total affected network sites, total damaged network sites, currently damaged network sites, among others. FIGS. 12-13 illustrates a dashboard portal showing additional detailed alert information, including additional detailed information on various network sites, such as the site name, status of the site, site type, NE stage, site category, battery running (or alternative energy source running) sites, and impact levels among others for the various types of events (e.g., level 4, level 3, level 2, etc.). FIG. 14 illustrates a dashboard portal showing a geographic map visualization for a disaster event, wherein the map can show various layers, such as a disaster map or weather alert layer, network site layer and outage impact layer, coverage layer, and shop layers, among others.

Accordingly, system, methods, devices, and the like, provided in the example embodiments of the present disclosure allows for simple monitoring, managing, and reporting of disaster and weather-related events alert information, including network sites within affected geographic areas

It is understood that the specific order or hierarchy of blocks in the processes/flowcharts disclosed herein is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, microservice(s), segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Various further respective aspects and features of embodiments of the present disclosure may be defined by the following items:
Item [1]: An apparatus that may be configured to: retrieve, based on a defined schedule, one or more event-related alerts via a method of procedure (MOP); and send, based on a first request from a user, the retrieved one or more event-related alerts to a management module having a graphical user interface (GUI) portal, wherein the first request may include a request to view the retrieved one or more event-related alerts.
Item [2]: The apparatus according to item [1], wherein the one or more event-related alerts may include at least one of: wind, rain, snow, ice, cyclone, hurricane, tsunami, landslide, flood, heat wave, cold wave, wildfire, drought, earthquake, or natural disaster information.
Item [3]: The apparatus according to any one of items [1]-[2], wherein the apparatus may be configured to: send the one or more event-related alerts to a first service module.
Item [4]: The apparatus according to any one of items [1]-[3], wherein the apparatus may be configured to: validate, via the first service module, the retrieved one or more event-related alerts based on one or more conditions.
Item [5]: The apparatus according to any one of item [1]-[4], wherein the apparatus may be configured to retrieve, via the first service module, one or more network site information in connection with the one or more event-related events from a second service module.
Item [6]: The apparatus according to item [5], wherein the second service module may include at least one of: a network fault management, network coverage management, network inventory management, network user management, network platform management, and customer support management.
Item [7]: The apparatus according to any one of items [1]-[6], wherein the management module may further include at least one of: an alerts list, alerts map, alert alarm codes list, active alerts alarm list, and alerts alarm history.
Item [8]: The apparatus according to any one of items [1]-[7], wherein the apparatus may be configured to: display, via the GUI portal, the one or more event-related alerts on a geographical map.
Item [9]: The apparatus according to any one of items [2]-[8], wherein the apparatus may be configured to: identify one or more network site locations affected by the one or more event-related alerts.
Item [10]: The apparatus according to item [9], wherein the apparatus may be configured to: display, via the GUI portal, the identified network site locations based on a second request from the user.
Item [11]: A method that may include: retrieving, based on a defined schedule, one or more event-related alerts via a method of procedure (MOP); and sending, based on a first request from a user, the retrieved one or more event-related alerts to a management module having a graphical user interface (GUI) portal, wherein the first request may include a request to view the retrieved one or more event-related alerts.
Item [12]: The method according to item [11], wherein the one or more event-related alerts may include at least one of: wind, rain, snow, ice, cyclone, hurricane, tsunami, landslide, flood, heat wave, cold wave, wildfire, drought, earthquake, or natural disaster information.
Item [13]: The method according to any one of items [11]-[12], may further include: sending the one or more event-related alerts to a first service module.
Item [14]: The method according to item [13], may further include: validating, via the first service module, the retrieved one or more event-related alerts based on one or more conditions.
Item [15]: The method according to any one of items [11]-[14], may further include: retrieving, via the first service module, one or more network site information in connection with the one or more event-related events from a second service module.
Item [16]: The method according item [15], wherein the second service module may include at least one of: a network fault management, network coverage management module, network inventory management, network user management, network platform management, and customer support management.
Item [17]: The method according to any one of items [11]-[16], wherein the management module may further include at least one of: an alerts list, alerts map, alert alarm codes list, active alerts alarm list, and alerts alarm history.
Item [18]: The method according to any one of items [11]-[17], may further include: displaying, via the GUI portal, the one or more event-related alerts on a geographical map.
Item [19]: The method according to any one of items [12]-[18], may further include: identifying one or more network site locations affected by the one or more event-related alerts.
Item [20]: A non-transitory computer-readable recording medium having recorded thereon instructions executable by an apparatus to cause the apparatus to perform a method that may include: retrieving, based on a defined schedule, one or more event-related alerts via a method of procedure (MOP); and sending, based on a first request from a user, the retrieved one or more event-related alerts to a management module having a graphical user interface (GUI) portal, wherein the first request may include a request to view the retrieved one or more event-related alerts.

It can be understood that numerous modifications and variations of the present disclosure are possible in light of the above teachings. It will be apparent that within the scope of the appended clauses, the present disclosures may be practiced otherwise than as specifically described herein.

What is claimed is:

1. An apparatus configured to:
retrieve, based on a defined schedule, one or more event-related alerts via a method of procedure (MOP); and
send, based on a first request from a user, the retrieved one or more event-related alerts to a management module having a graphical user interface (GUI) portal;
wherein the first request comprises a request to view the retrieved one or more event-related alerts.

2. The apparatus of claim 1, wherein the one or more event-related alerts are comprised of at least one of: wind, rain, snow, ice, cyclone, hurricane, tsunami, landslide, flood, heat wave, cold wave, wildfire, drought, earthquake, or natural disaster information.

3. The apparatus of claim 1, wherein the apparatus is configured to:
send the one or more event-related alerts to a first service module.

4. The apparatus of claim 3, wherein the apparatus is configured to:
validate, via the first service module, the retrieved one or more event-related alerts based on one or more conditions.

5. The apparatus of claim 1, wherein the apparatus is configured to:
retrieve, via the first service module, one or more network site information in connection with the one or more event-related events from a second service module.

6. The apparatus of claim 5, wherein the second service module comprises at least one of: a network fault management, network coverage management, network inventory management, network user management, network platform management, and customer support management.

7. The apparatus of claim 1, wherein the management module further comprises at least one of: an alerts list, alerts map, alert alarm codes list, active alerts alarm list, and alerts alarm history.

8. The apparatus of claim 1, wherein the apparatus is configured to:
display, via the GUI portal, the one or more event-related alerts on a geographical map.

9. The apparatus of claim 2, wherein the apparatus is configured to:
identify one or more network site locations affected by the one or more event-related alerts.

10. The apparatus of claim 9, wherein the apparatus is configured to:
display, via the GUI portal, the identified network site locations based on a second request from the user.

11. A method comprising:
retrieving, based on a defined schedule, one or more event-related alerts via a method of procedure (MOP); and
sending, based on a first request from a user, the retrieved one or more event-related alerts to a management module having a graphical user interface (GUI) portal;
wherein the first request comprises a request to view the retrieved one or more event-related alerts.

12. The method of claim 11, wherein the one or more event-related alerts are comprised of at least one of: wind, rain, snow, ice, cyclone, hurricane, tsunami, landslide, flood, heat wave, cold wave, wildfire, drought, earthquake, or natural disaster information.

13. The method of claim 11, further comprising:
sending the one or more event-related alerts to a first service module.

14. The method of claim 13, further comprising:
validating, via the first service module, the retrieved one or more event-related alerts based on one or more conditions.

15. The method of claim 11, further comprising:
retrieving, via the first service module, one or more network site information in connection with the one or more event-related events from a second service module.

16. The method of claim 15, wherein the second service module comprises at least one of: a network fault management, network coverage management, network inventory management, network user management, network platform management, and customer support management.

17. The method of claim 11, wherein the management module further comprises at least one of: an alerts list, alerts map, alert alarm codes list, active alerts alarm list, and alerts alarm history.

18. The method of claim 11, further comprising:
displaying, via the GUI portal, the one or more event-related alerts on a geographical map.

19. The method of claim 12, further comprising:
identifying one or more network site locations affected by the one or more event-related alerts.

20. A non-transitory computer-readable recording medium having recorded thereon instructions executable by an apparatus to cause the apparatus to perform a method comprising:
retrieving, based on a defined schedule, one or more event-related alerts via a method of procedure (MOP); and
sending, based on a first request from a user, the retrieved one or more event-related alerts to a management module having a graphical user interface (GUI) portal;
wherein the first request comprises a request to view the retrieved one or more event-related alerts.
